(19) United States
(12) Patent Application Publication
(10) Pub. No.: US 2017/0238329 A1
(43) Pub. Date: Aug. 17, 2017

(54) UE-MEASUREMENT ASSISTED CLOSED LOOP LEARNING APPROACH FOR REAL-TIME OPTIMIZATION OF SYSTEM METRICS

(71) Applicant: Spidercloud, Inc., Milpitas, CA (US)

(72) Inventors: Jaspreet Singh, San Jose, CA (US); Tsung-Yi Chen, San Jose, CA (US); Hithesh Nama, San Jose, CA (US)

(21) Appl. No.: 15/233,467

(22) Filed: Aug. 10, 2016

Related U.S. Application Data
(60) Provisional application No. 62/295,220, filed on Feb. 15, 2016.

(51) Int. Cl. H04W 72/08; H04W 52/14; H04W 52/24; H04W 72/04

(52) U.S. Cl. CPC H04W 72/085; H04W 72/048; H04W 52/143; H04W 52/241

(57) ABSTRACT

A method for assessing an impact of a design choice on a system level performance metric of a radio access network (RAN) deployed in an environment includes receiving messages from a plurality of UEs over time by a plurality of RNs in the RAN. A design choice is selected for a set of operating parameters of the RAN. One or more of measurement values in each of the received messages and the selected design choice are processed to compute a set of derivatives. A system level performance metric is determined as a function of the computed set of derivatives.

### CROSS-REFERENCE TO RELATED APPLICATION

This application claims the benefit of U.S. Provisional Application No. 62/295,220, filed Feb. 15, 2016, which is incorporated herein by reference in its entirety.

### BACKGROUND

Operators of mobile systems, such as universal mobile telecommunications systems (UMTS) and its offspring including LTE (long term evolution) and LTE-advanced, continue to rely on advanced features to improve the performance of their radio access networks (RANs). These RANs typically utilize multiple-access technologies capable of supporting communications with multiple users using radio frequency (RF) signals and sharing available system resources such as bandwidth and transmit power.

Planning a deployment of radio cells in a RAN is a complex task, which requires taking into consideration a variety of parameters. As an example, consider the deployment of a network of radio cells inside a building for the purpose of providing improved indoor voice and data services to enterprises and other customers. Such a network may be referred to as a small cell RAN. In such a deployment, the parameters that typically need to be taken into consideration for network planning include: a particular layout of the building, propagation and absorption characteristics of the building, specific radio interface(s) supported by the radio cells, specific characteristics of the radio cells, interferences between radio cells, etc. To obtain an optimal coverage, the deployed radio cells need to be positioned close enough to each other, while at the same time minimizing interference between them. Also, the position of each radio cell should be selected judiciously to minimize the total number of radio cells required to obtain optimal coverage.

As a part of the RAN deployment, there are a number of tasks that need to be accomplished, each of which requires making design choices to optimize the network. For instance, typical tasks include, by way of example, frequency planning to assign frequencies (i.e., spectrum) to individual cells, assignment of downlink transmit powers to the base stations in each cell, and the optimization of various network algorithms.

### SUMMARY

In accordance with one aspect of the subject matter disclosed herein, a method is provided for assessing an impact of a design choice on a system level performance metric of a radio access network (RAN) deployed in an environment. In accordance with the method, messages are received from a plurality of UEs over time by a plurality of RNs in the RAN. A design choice is selected for a set of operating parameters of the RAN. One or more of measurement values in each of the received messages and the selected design choice are processed to compute a set of derivatives. A system level performance metric is determined as a function of the computed set of derivatives.

### BRIEF DESCRIPTION OF THE DRAWINGS

FIG. 1 shows an enterprise in which a small cell RAN is implemented.

FIG. 2 shows a functional block diagram of one example of an access controller such as the SpiderCloud services node.

FIG. 3 shows a series of cells in a RAN overlaid with a dense grid of points.

### DETAILED DESCRIPTION

The network planning design choices (e.g., frequency planning, transmit powers, etc) that are made are selected to optimize one or more system level performance metrics. Typical examples of such metrics include the average spatial spectral efficiency, the link capacity and overall system capacity. In the case of the spatial spectral efficiency, for instance, the impact of each design choice (e.g., transmit powers) on the spectral spatial efficiency needs to be determined at every point in space and then averaged out. In this way various design choices may be examined and the one that most nearly optimizes the spatial spectral efficiency may be chosen.

While a number of these design choices can be performed to some degree using simulations based on models, they may not accurately reflect the topology of the actual deployed network and thus the resulting design choices that are made may not be optimal. In many cases it would be preferable to make these design choices based on the network and topology as actually deployed, and to do so in a real-time manner.

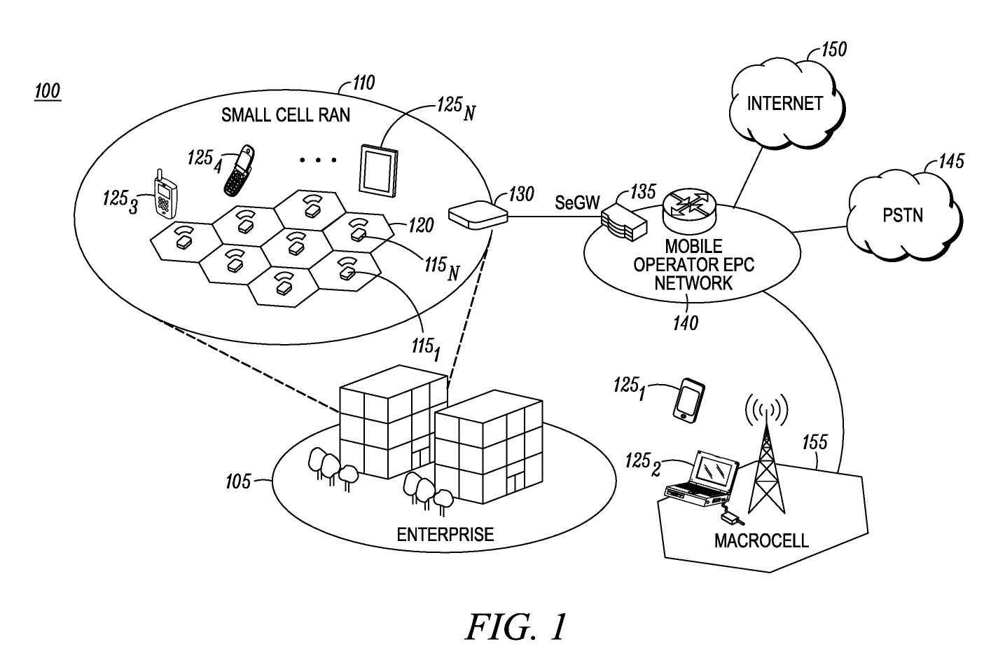

For deployment-based optimization of system metrics, in order to determine the overall system impact of a design choice on a performance metric, a central processor or other entity is needed. Some RANs employ an access controller that can be used to perform this task. One example of an access controller that operates in a mobile small cell RAN 110 is the SpiderCloud Services Node, available from SpiderCloud Wireless, Inc. Details concerning the SpiderCloud Services Node may be found in U.S. Pat. No. 8,982,841, which is hereby incorporated by reference in its entirety. This services node is illustrated below in FIG. 1 in the context of a mobile communications environment in which the services node controls individual radio nodes (which are equivalent to base stations communicating with the user equipments (UEs)) in a RAN.

FIG. 1 shows an enterprise 105 in which a small cell RAN 110 is implemented. The small cell RAN 110 includes a plurality of radio nodes (RNs) 115₁ . . . 115_{N}. Each radio node 115 has a radio coverage area (graphically depicted in the drawings as hexagonal in shape) that is commonly termed a small cell. A small cell may also be referred to as a femtocell, or using terminology defined by 3GPP as a Home Evolved Node B (HeNB). In the description that follows, the term “cell” typically means the combination of a radio node and its radio coverage area unless otherwise indicated. A representative cell is indicated by reference numeral 120 in FIG. 1.

The size of the enterprise 105 and the number of cells deployed in the small cell RAN 110 may vary. In typical implementations, the enterprise 105 can be from 50,000 to 500,000 square feet and encompass multiple floors and the small cell RAN 110 may support hundreds to thousands of users using mobile communication platforms such as mobile phones, smartphones, tablet computing devices, and the like (referred to as “user equipment” (UE) and indicated by reference numerals 1251-N in FIG. 1).

The small cell RAN 110 includes an access controller 130 that manages and controls the radio nodes 115. The radio nodes 115 are coupled to the access controller 130 over a direct or local area network (LAN) connection (not shown in FIG. 1) typically using secure IPsec tunnels. The access controller 130 aggregates voice and data traffic from the radio nodes 115 and provides connectivity over an IPsec tunnel to a security gateway SeGW 135 in an Evolved Packet Core (EPC) 140 network of a mobile operator. The EPC 140 is typically configured to communicate with a public switched telephone network (PSTN) 145 to carry circuit-switched traffic, as well as for communicating with an external packet-switched network such as the Internet 150.

The environment 100 also generally includes Evolved Node B (eNB) base stations, or “macrocells”, as representatively indicated by reference numeral 155 in FIG. 1. The radio coverage area of the macrocell 155 is typically much larger than that of a small cell where the extent of coverage often depends on the base station configuration and surrounding geography. Thus, a given UE 125 may achieve connectivity to the network 140 through either a macrocell or small cell in the environment 100.

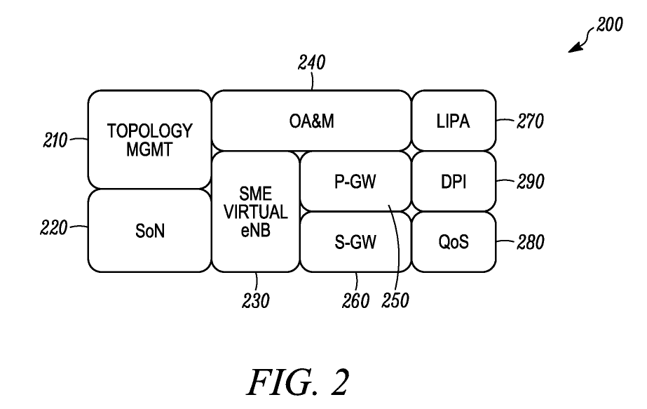

As previously mentioned, one example of an access controller is the SpiderCloud Services Node, available from SpiderCloud Wireless, Inc. FIG. 2 shows a functional block diagram of one example of an access controller such as the SpiderCloud services node. The access controller may include topology management, self-organizing network (SON), radio resource management (RRM), a services node mobility entity (SME), operation, administration, and management (OAM), PDN GW/PGW, SGW, local IP access (LIPA), QoS, and deep packet inspection (DPI) functionality. Alternative embodiments may employ more or less functionality/modules as necessitated by the particular scenario and/or architectural requirements. Because the services node described above is in communication with the entire RAN, it is able to assess the impact of a design choice on the level of the whole system. Accordingly, it may be used as part of a real time, deployment-based, process for performing system level optimization of performance metrics based on various design choices.

In some embodiments the access controller may be incorporated into a cloud-based gateway that may be located, for example, in the mobile operator's core network and which may be used to control and coordinate multiple RANs. Examples of such a gateway are shown in co-pending U.S. application. Nos. [Docket Nos. 8 and 8C1], which are hereby incorporated by reference in their entirety.

One example of a technique for performing such real-time, system level optimization is described below. In this technique, UE measurement reports are used by the centralized services node in order to predict the system level metric for different potential design choices, as per the disclosed embodiments. The UE measurement report provides signal strength measurements made by a UE of the signals received from different radio nodes. The optimizing design choice can then be employed for operation. Further, with continuing operation in a dynamic environment, the optimum design choice will likely need to be updated by incorporating the latest measurements. The RAN is thus a real-time self-optimizing system. Of course, the disclosed techniques are not limited to the particular small cell RAN or the particular access controller shown above, which are presented for illustrative purposes only. For instance, the disclosed techniques could apply to other radio access networks consisting of a macro cells or a mix of macro and small cells, etc.

In order to compute a system level performance metric, knowledge of a derivative such as the signal-to-interference+noise ratio (SINR) across the system is needed. The SINR may be defined as:

$$SINR = \frac{Received power from serving cell}{ \begin{matrix} Sum of received powers from interfering cells + \\ Noise power \end{matrix} }$$

The SINR needs to be known at all spatial locations across the system. That is, the SINR(x) is needed for all x, where x denotes the spatial coordinates of a point in the system (i.e., the RAN deployment). So, typically, the system metric would be

System metric=Eₓ(f(SINR(x)))

Where f( ) is some metric of interest (e.g., spectral efficiency), and Eₓ( ) denotes the expectation operator based on the probability distribution of the location x, e.g., x can be uniformly distributed across the cell coverage area.

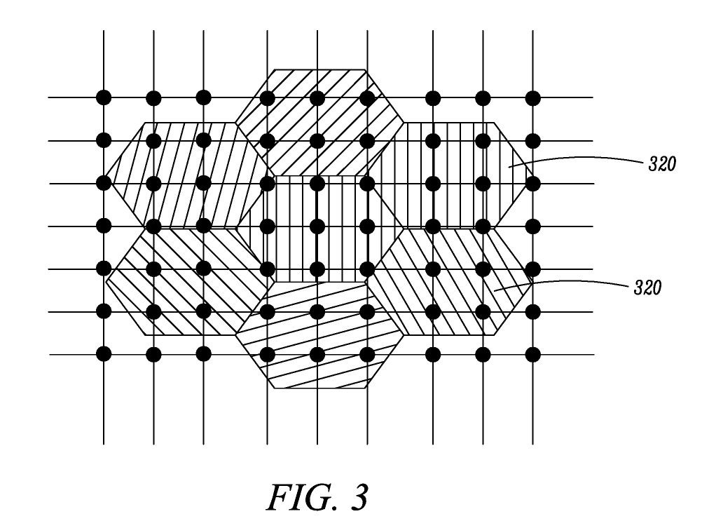

In practice, instead of determining the SINR or other derivative for every point x, the system performance can be approximated by evaluating the system metric over a dense grid of points, as illustrated in FIG. 3 for cells 320. Even still, evaluating the SINR at a finite number of points in the system remains highly challenging because it would require knowledge of the exact geographic topology, and the ability to construct the exact propagation/path loss models at all points on the grid. However, this problem can be overcome by using measurement data obtained from UEs that communicate with the RNs in the RAN. That is, the UEs can report data such as the signal power they receive from the RNs. The RNs in turn forward the data to the access controller. Given enough data points from the UEs, which presumably come from a sufficiently large sample of locations in the system, the system metric in question can be approximated based on the real-world data from the UEs. This approach has the added benefit that the metric of interest is optimized for the locations where users are most likely to be connected to and using the RAN.

In one embodiment, the measurement data may be obtained from Radio Resource Control (RRC) Measurement Reports. Such reports are generated by a UE when the UE receives RF signals from the serving cell RN and potential RNs to which the UE may be handed off. The RRC measurement reports include data pertaining to signal measurements of signals received by the UE from various RNs. There are multiple HO-triggering or Measurement Report-triggering events (generally referred to herein as a triggering event) defined for an LTE cellular network. When the criteria or conditions defined for a triggering event are satisfied, the UE will generate and send a Measurement Report to its serving cell RN. Currently, there are eight different triggering events defined for E-UTRAN in section 5.5.4 of the 3GPP Technical Specification (TS) 36.331, version 12.2.0 (June 2014), titled “3^{rd} Generation Partnership Project; Technical Specification Group Radio Access Network; Evolved Universal Terrestrial Radio Access (E-UTRA); Radio Resource Control (RRC); Protocol specification (Release 12).”

Measurement data may be obtained from RRC measurement reports that are both event-triggered and periodically generated. Illustrative event-triggered reports include, without limitation, handover events (e.g., A3/A4/A5/A6/B1/B2 for LTE, 1c/1d for UMTS) and serving cell coverage events (e.g., A1/A2 for LTE, 1a/1b for UMTS). The measurement data that may be included in the reports from which SINR may be approximated include one or more of the following parameters: RSRP, RSRQ for LTE, RSCP, RSSI, Ec/Io for UMTS and CQI reports for both LTE and UMTS.

The system performance metric is to be determined as a function of a selected design choice (e.g., the transmit powers to use in different cells). Thus, the system metric may be expressed as:

System metric(design choice)=Eₓ(f(SINR(x,design choice)))

Note that the SINR is a function of both the spatial location x and the design choice.

In one embodiment, the SINRs are predicted using PCI (to identify the cell) and RSRP data. Thus, if a UE sends a measurement report from each of k cells that it receives a signal from, a UE report may be assembled from the various reports as follows:

UEᵣₑₚₒᵣₜ=[(PCI₁,RSRP₁); (PCI₂,RSRP₂); . . . (PCI_{K},RSRP_{K})]

Where the set of reports is represented by:

S_{R}=[UEreport₁,UEreport₂, . . . ,UEreport_{R}]

Each UE report can be used to predict the SINR that would be achieved by a UE at the corresponding location for the given design choice. Once a sufficient number of measurement reports are received, a set of derivatives such as the SINR can be predicted for a dense spatial data points within the entire coverage area of the RAN. From this the desired system performance metric can be determined. Specifically, the expectation over x (i.e., over space) can be replaced with the expectation over the set of UE measurement reports, as follows

System metric(design choice)=E_{y}(f(SINR(y,design choice))),

where y denotes a measurement report. One example of a distribution of y could be the uniform distribution where all measurement reports are equally weighted. Another example could be an exponential distribution over time with older measurements being accorded lower probability than more recent measurements.

An example will now be presented to illustrate the method described above. Of course, the exact determination of the SINR (y, design choice) will vary depending on the system performance metric that is chosen and the design choice being optimized for that system performance metric.

Consider that the system metric of interest is the spectral efficiency defined as log(1+SINR) and the design choice to be optimized is the transmit power levels to be used in different cells. Let N=number of cells and denote P={P₁, P₂, . . . , P_{N}} as one particular choice of the transmit powers. Assume that the measurement report from a typical UE is:

y=[(PCI₁,RSRP₁); (PCI₂,RSRP₂); . . . (PCI_{K},RSRP_{K}]

The K PCIs reported by the UE are the PCIs for the K (out of N) cells from which the UE received a signal.

Using this report, the vector of RSRPs from the different cells can be defined, arranged according to the cell numbering scheme {1:N}, i.e., define RSRP_{vec}={R₁, R₂, . . . , R_{N}} (where only K out of these N values would be non-zero, as the UE detected only K cells).

Assuming that cell ‘m’ is the serving cell, the predicted SINR at the spatial location from which the UE report is sent is:

$$\begin{matrix}SINR ( y , [ {P}_{1} , {P}_{2} , … , {P}_{N} ] ) = \frac{Received power from serving cell}{ \begin{matrix}Sum of received powers from \\ interfering cells + n oise power\end{matrix} } \\ = \frac{\frac{{P}_{m} {R}_{m}}{{P}_{m}^{0}}}{{\sum }_{{i = 1}_{( i \neq m )} \\}^{N} {P}_{i} {R}_{i} / {P}_{i}^{0} + Noise power}\end{matrix}$$

where P⁰={P₁⁰, P₂⁰, . . . , P_{N}⁰}=denotes the cell transmit powers being used in the different cells when the UE measurement report is sent.

Based on the SINR computation above and assuming a uniform distribution of M reported measurements (say), the spectral efficiency system metric for a specific design choice is computed as

$$SpectralEfficiency ( [ {P}_{1} , {P}_{2} , … , {P}_{N} ] ) = \frac{1}{M} {\sum }_{i = 1}^{M} log ( 1 + SINR ( y , [ {P}_{1} , {P}_{2} , … , {P}_{N} ] )$$

The optimal choice of transmit powers can then be determined by evaluating the Spectral Efficiency for different sets of transmit powers and choosing the set of powers that maximizes the Spectral Efficiency.

Several aspects of telecommunication systems will now be presented with reference to access controllers, base stations and UEs described in the foregoing description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionalities described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable media. Computer-readable media may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable media for storing or transmitting software. The computer-readable media may be resident in the processing system, external to the processing system, or distributed across multiple entities including the processing system. Computer-readable media may be embodied in a computer-program product. By way of example, a computer-program product may include one or more computer-readable media in packaging materials. Those skilled in the art will recognize how best to implement the described functionality presented throughout this disclosure depending on the particular application and the overall design constraints imposed on the overall system.

1. A method for assessing an impact of a design choice on a system level performance metric of a radio access network (RAN) deployed in an environment, comprising:
receiving messages from a plurality of UEs over time by a plurality of RNs in the RAN;
selecting a design choice for a set of operating parameters of the RAN;
processing one or more of measurement values in each of the received messages and the selected design choice to compute a set of derivatives; and
determining a system level performance metric as a function of the computed set of derivatives.

2. The method of claim 1, wherein the set of derivatives comprises a signal-to-interference-and-noise ratio (SINR) at a plurality of spatial locations in the environment at which the UEs are located when the measurement values in the messages are measured.

3. The method of claim 1, wherein the set of derivatives comprises a logarithmic operation of signal-to-interference-and-noise ratio (SINR) at a plurality of spatial locations in the environment at which the UEs are located when measurement values in the messages are measured.

4. The method of claim 1, wherein the function is a weighted summation of the derivatives, where each derivative is associated with a unique weight.

5. The method of claim 4, wherein all weights are identical.

6. The method of claim 1, wherein the function selects the least derivative from among the set of derivatives.

7. The method of claim 1, wherein the messages are Radio Resource Control (RRC) measurement reports.

8. The method of claim 7, wherein the measurement values include a RSRP received from a specified cell.

9. The method of claim 7, wherein the measurement values are obtained from a report selected from the group including RSRQ for LTE, RSCP, RSSI, Echo for UMTS and CQI reports.

10. The method of claim 1, wherein the measurement values include a radio resource management (RRM) measurement value.

11. The method of claim 1, wherein processing the measurement values, selecting a design choice, and determining a system level performance metric are performed by an access controller operatively coupled to the RNs, the access controller being configured to receive the measurement reports from the RNs.

12. The method of claim 1, wherein the RAN is selected from the group including a small cell RAN, a macro network or a combination of a small cell RAN and a macro network.

13. The method of claim 6, wherein derivatives based on measurement values in more recent messages are given more weight than derivatives based on measurement values in less recent messages.

14. The method of claim 6, wherein derivatives based on measurement values in messages received from certain UEs are given more weight than derivatives based on measurement values received from other UEs.

15. The method of claim 14, wherein derivatives based on messages received from cell-edge UEs are given more weight than derivatives based on measurement values received from other UEs.

16. The method of claim 1, further comprising:
assessing an impact of each of a plurality of different design choices for the set of operating parameters; and
selecting for use in operation of the RAN the design choice that optimizes the system level performance metric.

17. The method of claim 1, wherein the design choice is a downlink transmit power from the RNs.

18. The method of claim 1, wherein the design choice is an operating frequency of each RN

19. The method of claim 2, further comprising a gateway that includes a plurality of access controllers each configured to control and coordinate a different RAN, the plurality of access controllers including said access controller that determines the SINR at a plurality of spatial locations in the environment.
